(19) United States
(12) Patent Application Publication
(10) Pub. No.: US 2012/0079451 A1
(43) Pub. Date: Mar. 29, 2012

(54) UNIFIED PROCESS TO DESIGN, DEVELOP, AND CONFIGURE USER INTERFACES

(75) Inventors: Ralf HALBEDEL, Heidelberg (DE); Marko DEGENKOLB, Wiesloch (DE)

(73) Assignee: SAP AG, Walldorf (DE)

(21) Appl. No.: 12/893,211

(22) Filed: Sep. 29, 2010

(51) Int. Cl. G06F 9/44

(52) U.S. Cl. 717/105

(57) ABSTRACT

A unified set of user interface (UI) tools are working on the same data and metadata, complying with a set of standards and guidelines in a central repository, the tools describing layout, interaction design, data binding, code, and partner- or customer-specific adaptations. By sharing this data the level of integration between the different people involved in the development process can be highly increased, as now there can be a closed loop which provides the necessary insight into each other's work. For example, the user interface designer may create the layout, the core developer may add the code which connects to the business logic, and the partner may add the specifics on top. This process can work in any direction, e.g., even after the developer has added the code, the user interface designer can later change the layout completely independent from the core developer.

### BACKGROUND

Embodiments of the present invention pertain to improving the development of computer programming including user interfaces.

Today, different people with different roles and competencies work with a variety of different tools in order to create and adapt user interfaces. This has the negative implication that those tools do not collaborate with each other. For example, a user interface designer typically uses a specific tool to model the layout and some interaction design of a user interface for a base application. The core developer cannot leverage from this design because he/she is using a different tool and thus has to create the user interface implementation from scratch. Thus, the core developer is forced to only use the user interface designer's work as a template which he/she needs to copy once again. The same is true for subsequent processes like user interface adaptation at partner and customer sites.

In view of the above there is a need for a method and system to provide a more efficient environment for the design, development and configuration of user interfaces.

### BRIEF DESCRIPTION OF THE DRAWINGS

FIG. 1 illustrates a central repository flow for user interface development and the different roles present in the development process.

FIG. 2 illustrates an example UI with a floorplan layout defined.

FIG. 3 illustrates an example floorplan manager component arrangement.

FIG. 4 illustrates with more detail another example floorplan manager arrangement.

FIG. 5 illustrates a dual flow interaction between two developer roles.

FIG. 6 illustrates an example system for implementing an example embodiment of the present invention.

### DETAILED DESCRIPTION

Embodiments of the present invention pertain to providing a central repository for user interface components that may be used by different individuals having different roles in creating and configuring a user interface for a base program. In one embodiment, individuals with different roles in the development of the user interface will have access to the same data and metadata for the user interface in the same central repository. For example, a user interface designer using his/her tools for generating the user interface will store the results of that work in the repository and those results, in turn, may be used by the independent software vendor(ISV)/partner developer to adapt the user interface for its particular implementation. Also, the work of the ISV/partner developer is stored in the central repository, and can be accessed by the user interface designer when changing or adding to the user interface.

According to embodiments of the present invention, each person having a particular role in developing/configuring the user interface will use their specific tools for their specific purposes in changing and modifying the user interface. As stated above, embodiments of the present invention provide that all these tools are working on the same data and metadata in a central repository, describing layout, interaction design, data binding, code, and partner- or customer-specific adaptations on top. By sharing this data, the level of integration between the different people involved in the development process can be highly increased, and there can be established a “closed loop” that provides the necessary insight into each other's work. For example, the user interface designer creates the layout, the core developer adds the code which connects to the business logic, and the partner adds his specifics on top. This process can also work in all directions: even after the developer has added the code, the user interface designer can later on change the layout completely independent from the core developer.

According to embodiments of the present invention, different people with different skills and different goals have specific roles in the development of user interfaces for a base software application. These roles may include user interface designers, core developers, and partner developers on the software development side, and consultants/power users and end-users on the customer side. Typically, there are specific solutions for different roles in user interface development. The specific solutions comprise different tools for building elements in different layers of a user interface. As described above, there is normally no end-to-end integration of the different tools employed in user interface development, and thus there is no common data and metadata, and no common enforcement of the constraints imposed on that data and metadata. Embodiments of the present invention use a central repository so that all roles in the user interface development process access the same data and meta-data. Further, the embodiments of the present invention enforce a set of standards and guidelines that all roles must follow in making changes to the user interface. Thus, a potential advantage of the present invention is that it reduces redundancy and inconsistencies in software user interface development across the whole range of roles in the development lifetime of the user interface.

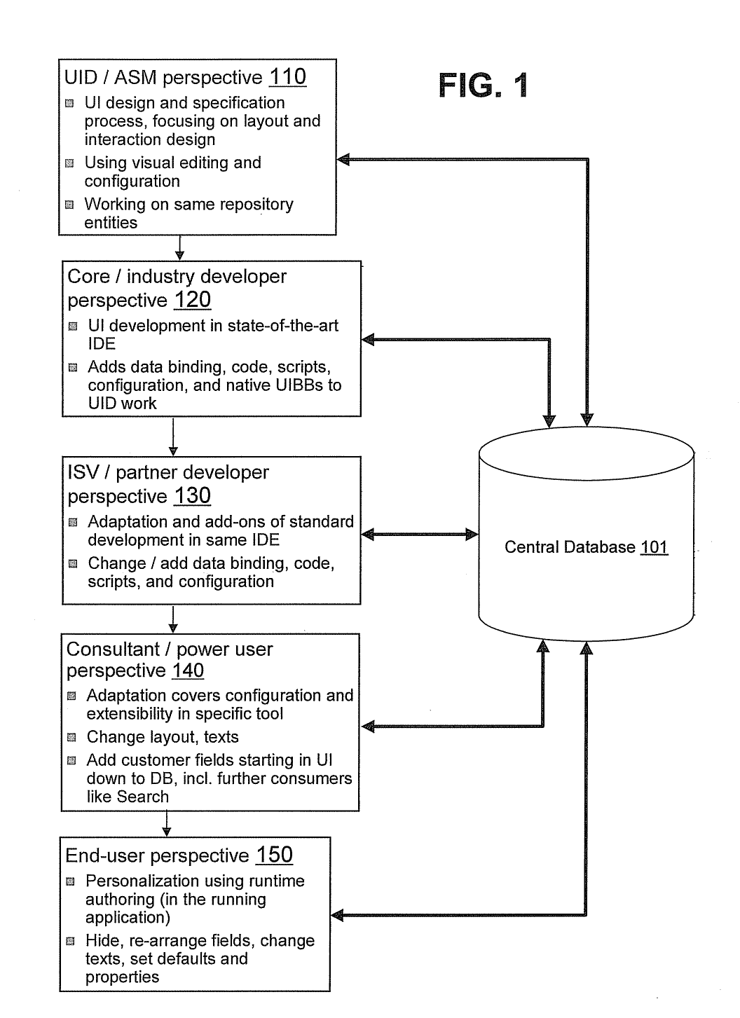

In identifying the different roles below, it is understood that the term user interface development includes all stages of work on the user interface during the lifetime of use of the user interface, including the design, coding, editing, updating, and configuration of the user interface. FIG. 1 illustrates an example flow of five different development roles, and the actions those roles may take. FIG. 1 is an exemplary illustration, and the order in which the different roles contribute to the final development may be in any number of ordered combinations and go back and forth between roles indefinitely.

The floorplan may be stored in a central repository, including meta-information, e.g., the rules and behavior that are specified for a given floorplan. The tools that are used by the different roles (UID, core developer, partner, consultant, end-user) may retrieve these rules from this central repository and use them as templates and constraints to ensure that the final application is compliant to the rules. Some of these rules may be specific to certain roles and tools, e.g., a UID's tool will comply with the layout rules of the floorplan, whereas a core developer's tool will comply with interaction rules and behavior, such as opening the next screen in a new window or replacing the existing one.

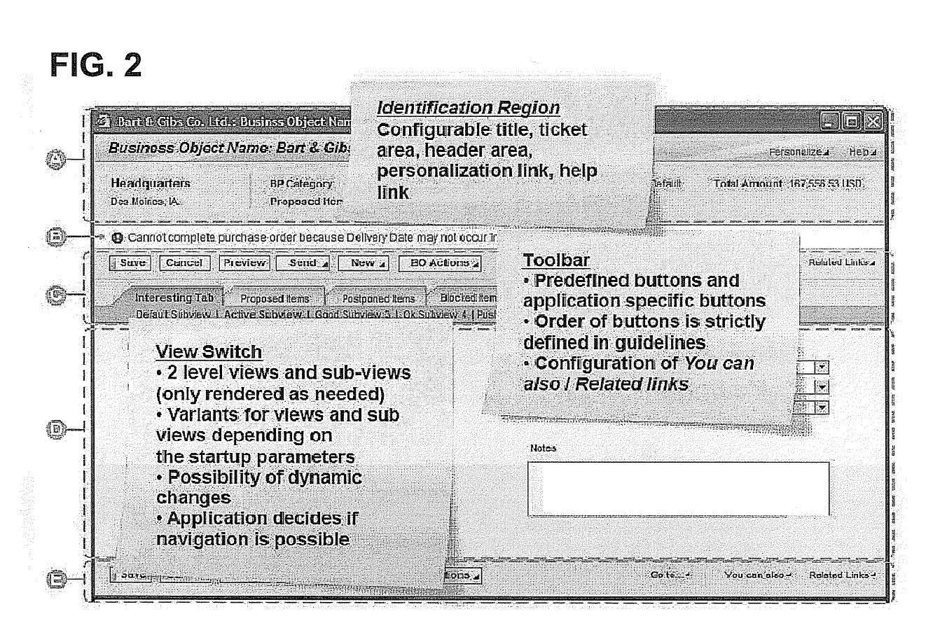

FIG. 2 illustrates an example user interface with various layout sections an example floorplan may define and/or control. For example, a plurality of sectioned areas may be defined within the potential space of the user interface (e.g., A to E). The layout may define an identification region A, which may also include certain rules, such as the inclusion of a configurable title, a ticket area, a header area, a personalization link, and a mandatory help link. The configurable title rule may indicate that a title is mandatory, such that any attempt to decode that feature would be blocked (and/or produce an error), but that the title may be adjusted/defined by one or more designer roles. The layout may further outline a message region B, and specify certain rules for what messages must and/or could be provided to the user in this area. The layout may further outline a contextual navigation region C, with definition for navigation buttons, tabbed hierarchies and organizational structures for navigation functions, etc. The main portion of the interface layout may include a view container D, which may present the substantive interface features associated with the current navigation selection. There may also be a contextual navigation region E, with another set of navigation choices, and another set of floorplan rules and guidelines.

Once a floorplan is established for the development or re-development of a user interface, each of a plurality of design roles may access a centrally stored interface, make changes relevant to their role, and a basic framework consistency may be maintained despite the use of otherwise incompatible and/or independent design tools. Several example roles are described below, in the context of FIG. 1.

A first role in the user interface development is the user interface designer, e.g. 110. The user interface designer creates the elements of the user interface with which a user interacts, and which are consistent with the standards, guidelines, and constraints of the chosen floorplan. In particular, the user interface designer's focus is on layout and interaction design. The user interface designer may use any development tool typically implemented for user interface design, including visual editing software.

A second role in the user interface development is the core/industry developer, e.g. 120. The core developer creates the business logic for performing various actions underlying the user interface. In particular, the core developer's focus is on adding data binding, code, scripts, and configurations. The core developer may use any tool typically implemented for creating the code for business logic, including an integrated development environment (IDE).

A third role in the user interface development is the Independent Software Vendor (ISV)/partner developer, e.g. 130. This role encompasses the modification of the standard user interface to meet the needs of a particular industry or to accomplish a specific set of tasks. In modifying the user interface, the ISV/partner developer may work on any layer within the user interface, by adapting layout and interaction design, changing or adding data binding, code, scripts, and configurations. In performing such adaptations, the ISV/partner developer may use any tools typically implemented for developing the specific layers of the user interface, including an IDE that may be the same or different than the IDE used by the core developer.

A fourth role in the user interface development is the consultant/power user, e.g. 140. This role encompasses making adaptations to the configuration and extensibility of the user interface at the customer premises. The focus of the consultant/power user is the specific needs of the company or customer employing the user interface. Adaptations include changes to the layout and texts of the user interface and additions of customer fields from the user interface layer down to the database.

A fifth role in the user interface development is the end-user, e.g. 150. The end-user role is the most limited role, but still entails significant freedom to personalize the look and feel of the user interface. Such freedoms include the ability to hide or re-arrange fields and change texts at the user interface layer, and to set defaults and properties. Due to the limited role of the end-user in user interface development, however, the end-user may be prohibited from attempting to change certain fields.

In addition, it is possible that further roles are present during the development lifetime of the user interface in different layers of the user interface, either on the software development side, the customer side, or in some capacity between the software and customer sides of development. There may also be any number of developers performing each role in the user interface development. FIG. 1 illustrates a typical flow in development from the user interface developer to the end-user. However, development may take place in any order of role, and different roles may develop and make changes to the user interface concurrently.

In an embodiment, a solutions manager sets standards and guidelines for a user interface design. These standards and guidelines are defined for a floorplan, which is a set of rules that the various development roles must abide by in developing and making changes to the user interface. The floorplan defines the behavior of the intended user interface, including the layout pattern, the interaction pattern, what types of navigation are allowed, what actions are possible, and that the user interface behaves similarly to different applications being developed independently, for example, if the user interface is being developed for an application that is part of a suite of applications.

The data and metadata for the user interface is stored in a central repository (e.g., 101). There exists a user interface development (UID) framework for providing access for each role in the user interface development to the central repository and for enforcing the floorplan rules regarding the data stored therein. The UID framework provides specific interfaces for each specific tool implemented by each role in the user interface development. The interfaces may comprise code within the UID framework itself, or may be installed in the specific tool implemented by a user interface development role as a plug-in or other piece of code. Thus, the different roles each have access to the same user interface data in the central repository as governed by the UID framework.

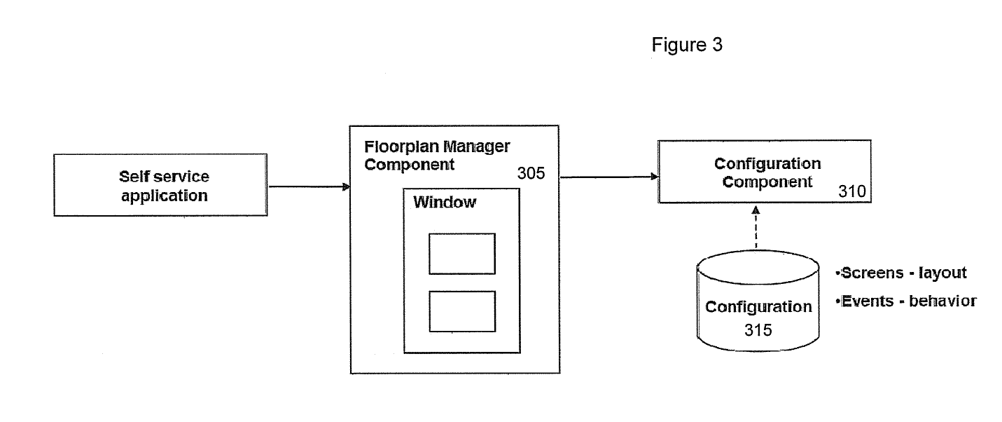

The UID framework (e.g., FIG. 3) may include a floorplan manager (FPM), e.g., 305. The floorplan manager is a central component (e.g., a WebDynpro®) component for providing the framework for a particular application. The floorplan manager may implement the different floorplans using configuration components, e.g. 310, which may call upon configuration data, e.g., 315. the floorplan manager may also initialize the application components, and dynamically build the various views defined by the standards, guidelines, rules, and constraints for both the layout and functional behavior. Further, the floorplan manager may include an interface for building visual components and enable the reuse of those visual components.

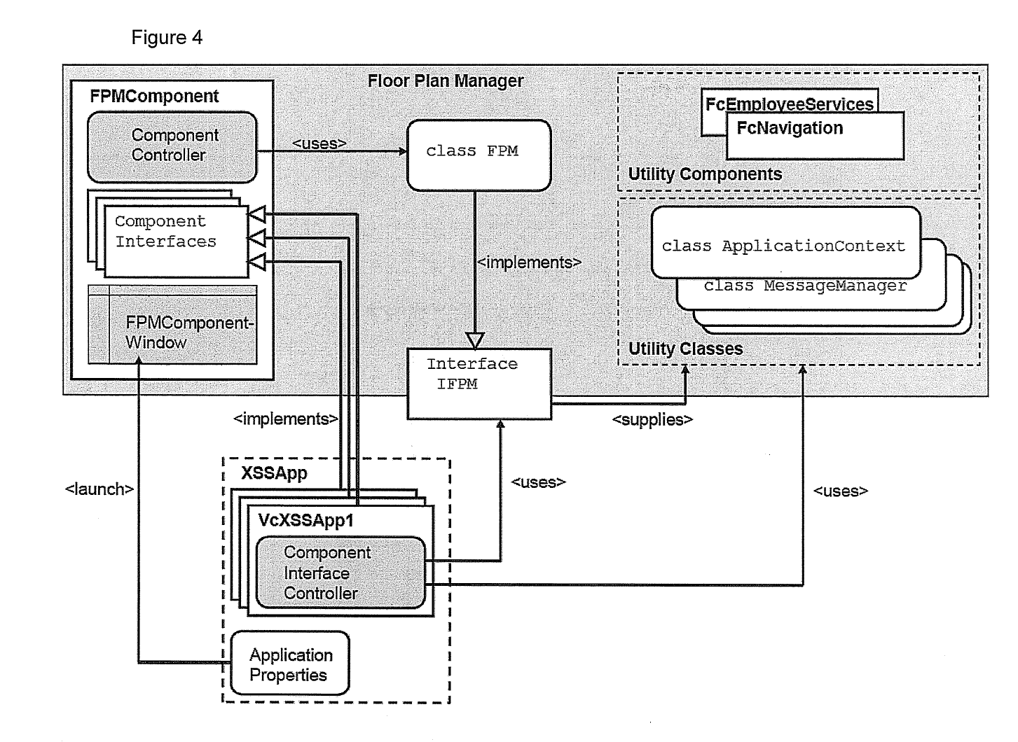

FIG. 4 illustrates this further. Here, the FPM Component includes a component controller and various component interfaces. There may also be a FPM Component interface (e.g., FPMComponent-Window) to provide application access to the FPM. An XSSApp may then launch the FPM Component interface and implement various component interfaces defined abstractly within the FPM Component module. The component controller may use the FPM class definition to implement an interface to the FPM as a whole. The FPM may define various utility components (e.g., employee services and/or navigation), and may define various utility classes (e.g., message management and/or application context, etc.). These utility classes may be defined by the FPM interface, and may be used by the application's component interface controller. Example embodiments of the FPM illustrated in FIG. 4 are more fully described in U.S. patent application Ser. No. 10/936,775, which is herein expressly incorporated by reference.

The central repository and the UID framework may be part of the same application, or the UID framework may be a separate application wherein the central repository is maintained in an external database. In either case, the UID framework may be stored on a hard disk drive or in system memory on a local or networked computer. The advantage of a UID framework made accessible on a networked computer is that many developers may concurrently access the same instance of the UID framework, which is in communication with a single central repository, whether the central repository exists in external storage or together with the UID framework in memory or on hard disk. On the customer side of user interface development, the UID framework and central repository may be integrated with the user interface in the same installation. Thus, an end-user may use a locally stored copy of the user interface, wherein any personalization of the user interface is made with reference to the UID framework and central repository existing on the same local computer as the user interface itself. Alternatively, the customer premises may contain a single instance of the UID framework and central repository that is stored on a network computer accessible by end-users working at the customer premises in order to implement personalized changes to their individual instances of the user interfaces. The individual instances of the user interfaces for the end-users in this alternative arrangement may be stored locally or on the same network accessible computer as the UID framework.

In all of the arrangements of the UID framework and central repository described in the preceding paragraph, the UID framework works to reduce redundancies during the development process, particularly on the software development side, and to ensure consistency in the operation and look and feel of the user interface both internally, from one screen to another within the same user interface, and universally, from one user interface to another, if, for example, the user interface is part of a suite or family of applications from the same vendor. By providing a mechanism for enforcing floorplan rules across all user interface development roles, the UID framework of the present invention leverages the user interface development process by extending it to partners, consultants, and end-users. This allows the original user interface designer and vendor to create flexible user interfaces that can be adapted to specific markets and customized by end-users, while ensuring that the original basic design will be respected.

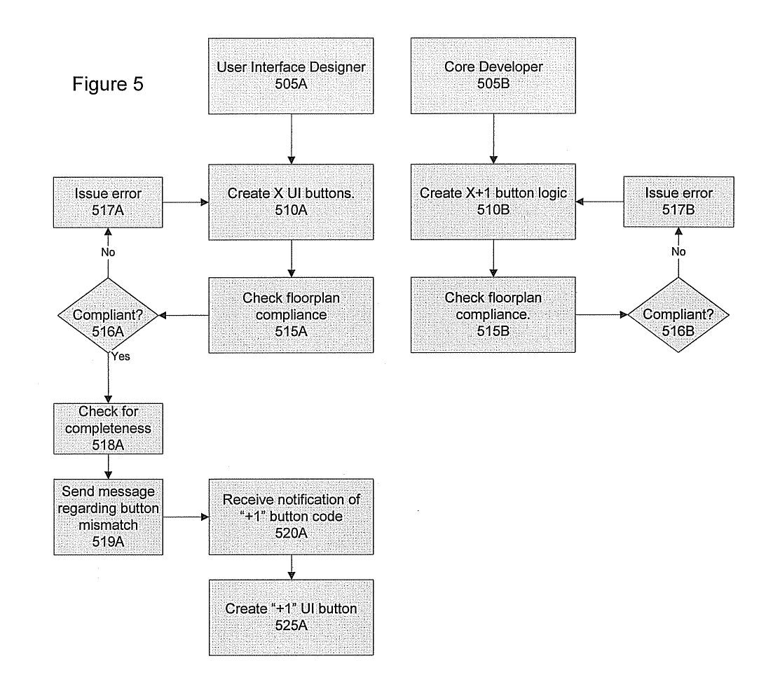

In one example on the software development side, as illustrated in FIG. 5, the user interface designer 505A may have created a number of interactive buttons X (e.g., 3) in a screen of the user interface, e.g., at 510A. The core developer (505B), however, may have implemented business logic for one button in addition to those created by the user interface designer (e.g., “X+1” or 4), as required by the user interface design and permitted by the floorplan, e.g., at 510B. After each of these actions, the respective tool may check for floorplan compliance (e.g., at 515 A and B), to ensure the respective actions conform to the defined floorplan for this interface. If it does not comply, the FPM may issues an error (e.g., 516 and 517 A and B). The FPM may also check for any mismatches, e.g., the disparity between the number of UI buttons designed and the number coded (e.g., at 518A).

Here, the FPM may send a message to the UI designer in a number of ways. The user interface designer may be made aware of the additional logic created by the core developer, which has been stored in the central repository, and may then create an additional button to work with the additional logic. The core developer in turn will make sure the new button works correctly with the code for the additional logic. In this example, the need for the user interface designer to create the additional button may be made apparent by a view in the user interface designer's specific tool, for example, a visual editor, which has access to the central repository via the specific interface to the UID framework. Alternatively, the UID framework includes a messaging protocol wherein a change made by one developer, for example, the core developer, which requires action by another developer, for example, the user interface developer, is explicitly communicated to the user interface developer via a message delivered to and displayed through the visual editor. When the user interface developer has made the required change (e.g., at 525A), another message is delivered to the core developer through the specific core development tool, for example, an IDE, implemented by the core developer (not shown). It is understood that this messaging protocol would operate similarly between the UID framework and any of the specific tools for the different roles for which a specific interface to the UID framework exists. It is further understood that the above example could similarly be illustrated by the addition of a new screen or a new step in a road map navigation or any other element within the user interface.

In another example on the customer side, an end-user wishes to hide a field in the user interface which is not permitted by the floorplan. In this case, the UID framework, which has the floorplan rules embedded within it, sends a message to the end-user that the particular action desired, i.e., to hide a particular field, is not allowed. This enforcement of the floorplan rules by the UID framework is important not only to maintain the look and feel of the user interface as designed by the solutions manager or user interface designer, but also to prevent introduction of new programming errors on the customer side of user interface development.

Various implementations of the systems and techniques described herein can be realized in any processing systems, computer hardware, software, and/or combinations thereof. The various implementations can include computer code.

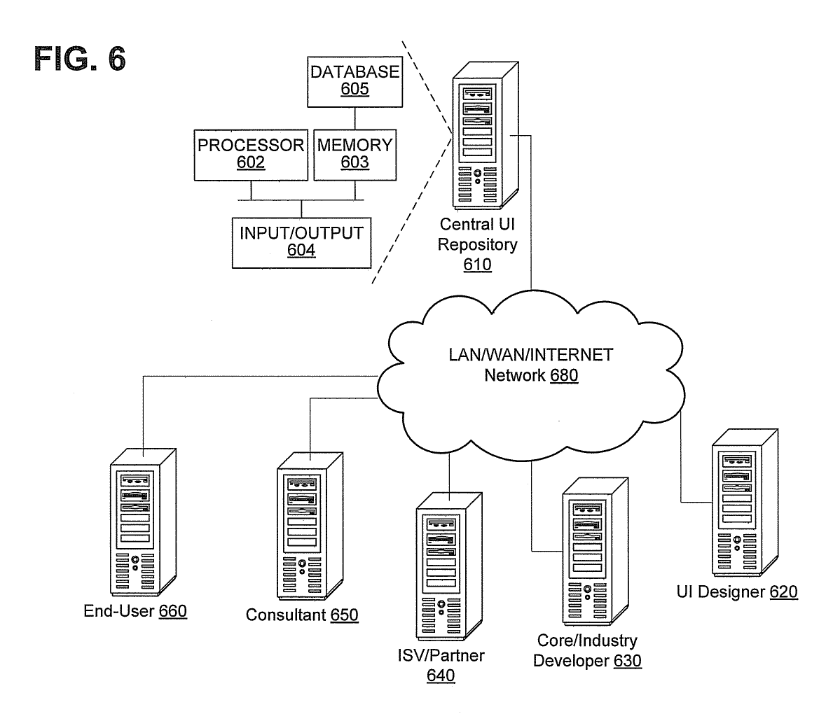

FIG. 6 illustrates an example system, according to an example embodiment of the present invention. The example may include one or more server computer systems, e.g., central repository 610. This may be one server, a set of local servers, or a set of geographically diverse servers. Each server may include an electronic computer processor 602, one or more sets of memory 603, including database repositories 605, and various input and output devices 604. These too may be local or distributed to several computers and/or locations. Any suitable technology may be used to implement embodiments of the present invention, such as general purpose computers. These system servers may be connected to one of more developer role systems 620 to 660 via a network 680, e.g., the Internet. The systems 620 to 660 can be general purpose computers including any kind of mobile devices. One or more system servers may operate hardware and/or software modules to facilitate the inventive processes and procedures of the present application, and constitute one or more example embodiments of the present invention. Further, one or more servers may include a computer readable medium, e.g., memory 603, with instructions to cause a processor, e.g., processor 602, to execute a set of steps according to one or more example embodiments of the present invention.

In addition to the embodiments of the present invention that are specifically described and illustrated herein, it will be appreciated that modifications and variations of the present invention are covered by the above teachings and within the purview of the appended claims without departing from the spirit and intended scope of the invention.

It will be appreciated that all of the disclosed methods and procedures described herein can be implemented using one or more computer programs or components. These components may be provided as a series of computer instructions on any conventional computer-readable medium, including RAM, ROM, flash memory, magnetic or optical disks, optical memory, or other storage media. The instructions may be configured to be executed by a processor which, when executing the series of computer instructions, performs or facilitates the performance of all or part of the disclosed methods and procedures.

We claim:

1. A unified user interface (UI) development system, comprising:
a central data storage repository that stores a plurality of standards and guidelines relating to the development of a UI;
an electronic processor configured to receive UI development instructions from each of a plurality of independent developer entities;
a floorplan stored in the central data storage repository that includes a set of rules each independent developer entity must conform to when developing and making changes to the UI.

2. The system of claim 1, wherein the floorplan includes a layout pattern for the UI.

3. The system of claim 1, wherein the floorplan is associated with a plurality of UIs under development and defines a common format for the plurality of UIs.

4. The system of claim 1, wherein each independent developer uses a unique development tool and the central data storage repository includes a unique tool interface for each development tool.

5. A unified user interface (UI) development method, comprising:
storing a plurality of standards and guidelines relating to the development of a UI in a central data storage repository;
receiving, with an electronic processor, UI development instructions from a plurality of independent developer entities;
storing a floorplan in the central data storage repository that is a set of rules that each independent developer entity must conform to when developing and making changes to the UI.

6. The method of claim 5, wherein the floorplan includes a layout pattern for the UI.

7. The method of claim 5, wherein the floorplan is associated with a plurality of UIs under development and defines a common format for the plurality of UIs.

8. The method of claim 5, wherein each independent developer uses a unique development tool and the central data storage repository includes a unique tool interface for each development tool.

9. A computer-readable storage medium encoded with instructions configured to be executed by a processor, the instructions which, when executed by the processor, cause the performance of a unified user interface (UI) development method, comprising:
storing a plurality of standards and guidelines relating to the development of a UI in a central data storage repository;
receiving, with an electronic processor, UI development instructions from a plurality of independent developer entities;
storing a floorplan in the central data storage repository that is a set of rules that each independent developer entity must conform to when developing and making changes to the UI.

10. The computer-readable storage medium of claim 9, wherein the floorplan includes a layout pattern for the UI.

11. The computer-readable storage medium of claim 9, wherein the floorplan is associated with a plurality of UIs under development and defines a common format for the plurality of UIs.

12. The computer-readable storage medium of claim 9, wherein each independent developer uses a unique development tool and the central data storage repository includes a unique tool interface for each development tool.
